(19) United States
(12) Patent Application Publication
(10) Pub. No.: US 2022/0246138 A1
(43) Pub. Date: Aug. 4, 2022

(54) LEARNING APPARATUS, SPEECH RECOGNITION APPARATUS, METHODS AND PROGRAMS FOR THE SAME

(71) Applicant: NIPPON TELEGRAPH AND TELEPHONE CORPORATION, Tokyo (JP)

(72) Inventors: Hiroshi SATO, Tokyo (JP); Takaaki FUKUTOMI, Tokyo (JP)

(73) Assignee: NIPPON TELEGRAPH AND TELEPHONE CORPORATION, Tokyo (JP)

(21) Appl. No.: 17/616,138

(22) PCT Filed: Jun. 7, 2019
(86) PCT No.: PCT/JP2019/022774

§ 371 Date: Dec. 2, 2021

(51) Int. Cl. G10L 15/16; G10L 15/19; G10L 15/06

(52) U.S. Cl. CPC G10L 15/16; G10L 15/063; G10L 15/19

(57) ABSTRACT

A learning device includes: a speech recognition portion configured to perform speech recognition processing on an acoustic feature value sequence O of an utterance unit using a recognition parameter λᵢₙᵢ, and obtain a recognition hypothesis Hₘ and an overall score xₘ; a hypothesis evaluation portion configured to evaluate the recognition hypothesis Hₘ and obtain an evaluation value Eₘ using a correct answer text that is a correct speech recognition result for the acoustic feature value sequence O; a reranking portion configured to obtain an overall score x_{m,k} for the recognition hypothesis Hₘ and give a rank rank_{m,k} thereto using a recognition parameter λₖ; an optimal parameter calculation portion configured to obtain, as a calculation result, an optimal value of a recognition parameter or a value expressing inappropriateness of the recognition parameter λₖ based on the evaluation value Eₘ and the rank rank_{m,k}; and a model learning portion configured to learn a regression model for estimating an optimal recognition parameter from an acoustic feature value sequence, using the acoustic feature value sequence O and the calculation result.

### TECHNICAL FIELD

The present invention relates to a learning device that learns a model to be used to estimate an optimal value of a recognition parameter in speech recognition, a speech recognition device that performs speech recognition using the optimal value estimated using the model, methods of the same, and a program.

### BACKGROUND ART

In HMM (Hidden Markov Model) speech recognition, a large number of parameters for adjusting behavior of a recognizer exist, and are called recognition parameters.

Regarding end-to-end speech recognition as well, scaling parameters between models exist for a configuration in which a plurality of models are combined, and change behavior of a recognizer. For example, end-to-end speech recognition with a language model has, as a parameter, a language weight that represents the degree to which the output of the language model is considered.

To improve recognition accuracy, those recognition parameters need to be set to appropriate values.

As a method for optimizing the recognition parameters, a method is commonly used in which recognition accuracy is calculated for a plurality of manually-prepared parameter sets using a dataset in which speech data is associated with transcription data, and the most accurate parameter set is employed.

There is a method in which appropriate recognition parameters are automatically set based on a dataset in which speech data is associated with transcription data (see NPLs 1 and 2).

Also, there is a method in which noise included in speech data is estimated, and a language model weight is adjusted in each frame using the estimation result (see NPL 3).

For example, a language model weight and an insertion penalty exist as recognition parameters that need to be adjusted during recognition. The language model weight is a parameter for balancing an acoustic model and a language model in a speech recognizer that has both of these models. The insertion penalty is a parameter for controlling the degree to which a recognition result with a large number of words or characters (hereinafter also referred to as “number of words or the like”) is suppressed, and the larger the insertion penalty, a recognition result with a smaller number of words or the like is more likely to be output.

### CITATION LIST

### Non Patent Literature

[NPL 1] Mak, B., & Ko, T., “Min-max discriminative training of decoding parameters using iterative linear programming”, In Ninth Annual Conference of the International Speech Communication Association. 2008.
[NPL 2] Tadashi Emori, Yoshifumi Onishi, Koichi Shinoda, “Efficient estimation method of scaling factors among probabilistic models in speech recognition”. Information Processing Society of Japan Research Report Speech Language Information Processing (SLP), 2007 (129 (2007-SLP-069)), 49-53, 2007.
[NPL 3] Novoa, J., Fredes, J., Poblete, V., & Yoma, N. B., “Uncertainty weighting and propagation in DNN-HMM-based speech recognition”, Computer Speech & Language, 47, 30-46, 2018.

### SUMMARY OF THE INVENTION

### Technical Problem

However, the optimal recognition parameters are not fixed for each input sentence. As an example, for example, as for speech mixed with noise, it is easier to obtain accurate speech recognition results if the language model is considered to be more important than the acoustic model. For this reason, performance is improved by increasing the language model weight.

In the methods in NPLs 1 and 2 in which fixed recognition parameters are set for a dataset of speech data and transcription data, the recognition parameters cannot be dynamically changed while capturing differences in the optimal recognition parameters depending on differences in properties between speech data.

NPL 3 describes a method that makes it possible to capture differences in the optimal recognition parameters depending on differences in properties between speech data. However, since the parameter estimation in NPL 3 is based on the results of noise recognition, acoustic phenomena other than noise that may affect appropriate parameters, such as clipping, cannot be captured.

An object of the present invention is to provide a speech recognition device that estimates an appropriate recognition parameter for each utterance without relying the results of noise estimation and performs speech recognition using the estimated recognition parameter, a learning device that learns a model to be used in the estimation, methods of the same, and a program.

### Means for Solving the Problem

To solve the above problem, according to an aspect of the present invention, a learning device includes: a speech recognition portion configured to perform speech recognition processing on an acoustic feature value sequence O of an utterance unit using a recognition parameter λᵢₙᵢ, and obtain a recognition hypothesis Hₘ and an overall score xₘ, where M is an integer of 1 or more and m=1, 2, . . . , M; a hypothesis evaluation portion configured to evaluate the recognition hypothesis Hₘ and obtain an evaluation value Eₘ using a correct answer text that is a correct speech recognition result for the acoustic feature value sequence O: a reranking portion configured to obtain an overall score x_{m,k} for the recognition hypothesis Hₘ and give a rank rank_{m,k} thereto using a recognition parameter λₖ, where K is an integer of 1 or more and k=1, 2, . . . , K; an optimal parameter calculation portion configured to obtain, as a calculation result, an optimal value of a recognition parameter or a value expressing inappropriateness of the recognition parameter λₖ based on the evaluation value Eₘ and the rank rank_{m,k}; and a model learning portion configured to learn a regression model for estimating an optimal recognition parameter from an acoustic feature value sequence, using the acoustic feature value sequence O and the calculation result.

To solve the above problem, according to another aspect of the present invention, a speech recognition device includes: a speech recognition portion configured to perform speech recognition processing on an acoustic feature value sequence O of an utterance unit using a recognition parameter λᵢₙᵢ, and obtain a recognition hypothesis Hₘ and an overall score xₘ, where M is an integer of 1 or more and m=1, 2, . . . , M; and a model use portion configured to obtain a recognition parameter λ_{E} for the acoustic feature value sequence O using a regression model for estimating an optimal recognition parameter from an acoustic feature value sequence, obtain an overall score xₘ for the recognition hypothesis Hₘ using the obtained recognition parameter λ_{E}, and rank the recognition hypothesis Hₘ based on the obtained overall score xₘ.

To solve the above problem, according to another aspect of the present invention, a learning device includes: a speech recognition portion configured to perform speech recognition processing on an acoustic feature value sequence O of an utterance unit using a recognition parameter λₖ, and obtain a recognition result Rₖ and an overall score xₖ, where K is an integer of 1 or more and k=1, 2, . . . , K; a hypothesis evaluation portion configured to evaluate the recognition result Rₖ and obtain an evaluation value Eₖ using a correct answer text that is a correct speech recognition result for the acoustic feature value sequence O; an optimal parameter calculation portion configured to obtain, as a calculation result, an optimal value of a recognition parameter or a value expressing inappropriateness of the recognition parameter λₖ based on the overall score xₖ and the evaluation value Eₖ for the recognition result Rₖ; and a model learning portion configured to learn a regression model for estimating an optimal recognition parameter from an acoustic feature value sequence, using the acoustic feature value sequence O and the calculation result.

To solve the above problem, according to another aspect of the present invention, a speech recognition device includes: a model use portion configured to obtain a recognition parameter λ_{E} for an acoustic feature value sequence O of an utterance unit using a regression model for estimating an optimal recognition parameter from an acoustic feature value sequence; and a speech recognition portion configured to perform speech recognition processing on the acoustic feature value sequence O using the recognition parameter λ_{E}.

### Effects of the Invention

According to the present invention, it is possible of achieve an effect that an appropriate recognition parameter can be estimated for each utterance without relying on the results of noise estimation.

### BRIEF DESCRIPTION OF DRAWINGS

FIG. 1 is a functional block diagram of a learning device according to a first embodiment.

FIG. 2 is a diagram showing an example of a processing flow of the learning device according to the first embodiment.

FIG. 3 is a functional block diagram of a speech recognition device according to a second embodiment.

FIG. 4 is a diagram showing an example of a processing flow of the speech recognition device according to the second embodiment.

FIG. 5 is a diagram showing a sentence error rate and a character error rate in a conventional method and the present method.

FIG. 6 is a diagram showing cases of improvement achieved by applying the present method.

FIG. 7 is a functional block diagram of a learning device according to a third embodiment.

FIG. 8 is a diagram showing an example of a processing flow of the learning device according to the third embodiment.

FIG. 9 is a functional block diagram of a speech recognition device according to a fourth embodiment.

FIG. 10 is a diagram showing an example of a processing flow of the speech recognition device according to the fourth embodiment.

FIG. 11 is a diagram showing an example configuration of a computer to which the present method is applied.

### DESCRIPTION OF EMBODIMENTS

Hereinafter, the embodiments of the present invention will be described. Note that in the diagrams used in the following description, constituent portions with the same functions and steps in which the same processing is performed are assigned the same signs, and redundant description is omitted. In the following description, symbols such as “\hat{ }” used in the text should originally be written directly above the preceding character, but due to limitations in text notation, those symbols are written immediately after the character. In formulas, these symbols are written at the original positions. Processing performed for each element of a vector or a matrix is applied to all elements of this vector or matrix unless otherwise stated.

<Points of First Embodiment>

In the present embodiment, an appropriate recognition parameter is directly estimated from an acoustic feature value sequence of an utterance unit, using a neural network. Note that in the present embodiment, the recognition parameter is a combination of a language weight and an insertion parameter. In the present embodiment, the recognition parameter is falsely changed with respect to a large number of recognition result candidates (hereinafter also referred to as “recognition hypotheses”) that are generated by performing speech recognition once using proper values of limited parameters such as a language model weight and an insertion parameter in the recognition parameter, and the recognition hypotheses are reranked.

Conventionally, it is common to use a fixed value as this recognition parameter, and the study of the point of focus of giving different recognition parameters for each utterance is limited. NPL 3 and Reference Literature 1 below are known regarding dynamic control of the language model weight.
(Reference Literature 1) Stemmer, G., Zeissler, V., Noeth, E., & Niemann, H., “Towards a dynamic adjustment of the language weight”, Springer, Berlin, Heidelberg, In International Conference on Text, Speech and Dialogue, pp. 323-328, 2001.

Reference Literature 1 suggests that dynamically changing the language weight on an utterance-by-utterance basis leads to improved recognition accuracy, and states that there is a possibility that the speed of speech and the reliability of recognition results can be used to estimate the language weight. However, since features that affect the appropriate language weight are diverse in reality, it is conceived that sufficient estimation cannot be performed even if such manually-selected features such as the speed of speech and the reliability of recognition results are used. In the present method, various kinds of information necessary for estimating the recognition parameter can be learned in a data-driven manner by accepting input of a feature value sequence and directly estimating the recognition parameter.

In the present embodiment, the method is applied as reranking. In the case of applying the method as reranking, recognition parameters called a language model weight and an insertion error can be optimized on a sentence-by-sentence basis. In the first embodiment, a model for estimating optimal parameters on a sentence-by-sentence basis is learned by means of reranking.

### First Embodiment

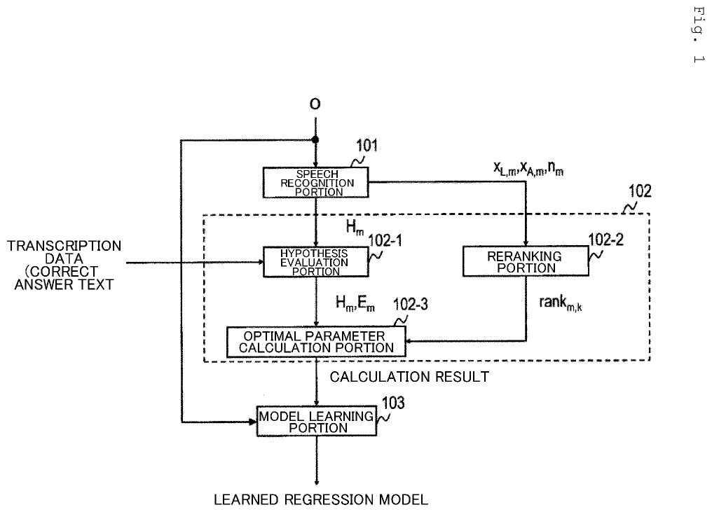

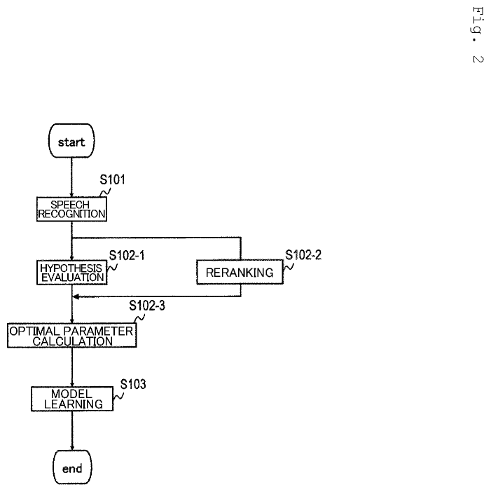

FIG. 1 is a functional block diagram of a learning device according to the first embodiment, and FIG. 2 shows a processing flow thereof.

The learning device includes a speech recognition portion 101, a hypothesis evaluation portion 102-1, a reranking portion 102-2, an optimal parameter calculation portion 102-3, and a model learning portion 103.

The learning device accepts input of an acoustic feature value sequence O_{L,p} for learning and transcription data obtained by a person transcribing corresponding speech data, learns a regression model for estimating an optimal recognition parameter from an acoustic feature value sequence, and outputs a learned regression model. The transcription data corresponds to correct answer texts that are the correct speech recognition results for the acoustic feature value sequences. The subscript L in O_{L,p} denotes an index indicating that the data is for learning, and p denotes an index indicating acoustic feature value sequences. For example, the learning device accepts input of P acoustic feature value sequences O_{L,p} for learning that correspond to P utterances, and transcription data thereof, where p=1, 2, . . . , P. It is desirable that various speech data for learning is prepared such that differences in optimal parameters depending on differences between speech data can be captured. Since the present embodiment only describes processing for the acoustic feature value sequences for learning, the index L is omitted. Also, since the same processing is performed for p=1, 2, . . . , P, the index p is omitted.

The learning device and a later-described speech recognition device are, for example, special devices that are configured by a special program loaded to a known or dedicated computer that has a central processing unit (CPU), a main storage device (RAM: Random Access Memory), and so on. The learning device and the speech recognition device execute processing under the control of the central processing unit, for example. Data input to the learning device and the speech recognition device and data obtained through processing are, for example, stored in the main storage device, and the data stored in the main storage device is loaded to the central processing unit and used in other processing as necessary. Each processing portion of the learning device and the speech recognition device may be at least partially constituted by hardware such as an integrated circuit. Each storage portion included in the learning device and the speech recognition device can be constituted by a main storage device such as a RAM (Random Access Memory), or middleware such as a relational database or a key value store, for example. However, each storage portion need not necessarily be provided in the learning device and the speech recognition device, and may alternatively be constituted by an auxiliary storage device that is constituted by a hard disk, an optical disk, or a semiconductor memory element such as a flash memory, and provided outside the learning device and the speech recognition device.

Each portion will be described below.

<Speech Recognition Portion 101>

The speech recognition portion 101 accepts input of an acoustic feature value sequence O of an utterance unit, performs speech recognition processing on the acoustic feature value sequence O of the utterance unit using a recognition parameter λᵢₙᵢ (S101), and obtains M recognition hypotheses Hₘ and M overall scores xₘ. Note that M is an integer of 1 or more, and m=1, 2, . . . , M. M indicates the number of recognition result candidates to be employed as the recognition hypotheses Hₘ. For example, recognition result candidates corresponding to the top M overall scores xₘ may be employed as the recognition hypotheses Hₘ. Alternatively, with the number of overall scores xₘ that exceed a predetermined threshold being M, M recognition result candidates corresponding to the M overall scores xₘ may be employed as the recognition hypotheses Hₘ. However, it is preferable that the number of candidates M is greater than the number of candidates that are output as candidates for usual speech recognition results. Since the recognition hypotheses are reranked while changing the recognition parameter and are used as bases for determining which recognition parameter is appropriate, a wide range of recognition results that may possibly be correct needs to be obtained, and there is a possibility that the larger the number of candidates is, the higher the accuracy is.

The speech recognition portion 101 outputs M recognition hypotheses Hₘ to the hypothesis evaluation portion 102-1, and outputs, to the reranking portion 102-2, M combinations of a language score x_{L,m}, an acoustic score x_{A,m}, and the number of words or the like nₘ that are obtained in the process of obtaining the M overall scores xₘ.

For example, the speech recognition portion 101 performs speech recognition using a known speech recognition technique and outputs a sufficient number (M) of recognition hypotheses on a sentence-by-sentence basis. The speech recognition portion 101 is required to be able to output the acoustic score, the language score, and the number of words or the like for each recognition hypothesis. Accordingly, for example, the speech recognition portion 101 needs to be one that includes a language model and an acoustic model that are represented by HMM speech recognition. The recognition parameter λᵢₙᵢ at the speech recognition portion 101 need not be precisely adjusted in advance with respect to a dataset using a method such as those in NPLs 1 and 2, and for example, the parameter of the language weight W_{L} can be set to a commonly used value (e.g., 10). Note that the language weight W_{L} is a parameter of weight in the case of presenting an overall score x of each recognition hypothesis as the sum an acoustic score x_{A} and a language score x_{L} using

x=x_{A}+W_{L}x_{L}+P_{I}n (1)

Here, P_{I} denotes an insertion penalty, and n denotes the number of words or the like.

A later-described optimal parameter estimation portion 102, which is constituted by the hypothesis evaluation portion 102-1, the reranking portion 102-2, and the optimal parameter calculation portion 102-3, estimates an optimal language model weight and an insertion penalty for the acoustic feature value sequences for learning, using each of the recognition hypotheses output from the speech recognition portion 101, as well as the language score, the acoustic score, and the number of words or the like of each hypothesis, and transcription data transcribed by a person.

The content of processing performed by each portion will be described below.

<Hypothesis Evaluation Portion 102-1>

The hypothesis evaluation portion 102-1 accepts input of the recognition hypotheses Hₘ and the correct answer texts, evaluates the recognition hypotheses Hₘ based on the correct answer texts, obtains evaluation values Eₘ (S102-1), and outputs the obtained evaluation values Eₘ. In other words, the hypothesis evaluation portion 102-1 is a portion that gives evaluation values representing the goodness of recognition to the recognition hypotheses obtained through speech recognition by the speech recognition portion 101. The hypothesis evaluation portion 102-1 calculates a sentence correct answer rate (0 or 1), a character correct answer accuracy (real number from 0 to 1), or the like, for each recognition hypothesis using a known technique as an evaluation method. This is an evaluation method in which, for each sentence, the sentence correct answer rate is 1 when a correct answer text transcribed by a person completely coincides with the recognition result, and is 0 in other cases, and the character correct answer accuracy cacc. is calculated using the following formula.

cacc.=(HIT−INS)/(HIT+SUB+DEL) (2)

Here, HIT denotes the number of correct characters, DEL denotes the number of incorrectly deleted characters, SUB denotes the number of incorrectly replaced characters, and INS denotes the number of incorrectly inserted characters. The hypothesis evaluation portion 102-1 outputs a set (Hₘ, Eₘ) of each recognition candidate and a value that is obtained by the evaluation using the above-described scale.

<Reranking Portion 102-2>

The reranking portion 102-2 accepts input of the M combinations of the language score x_{L,m}, the acoustic score x_{A,m}, and the numbers of words or the like nₘ, obtains K overall scores x_{m,k} for each of the M recognition hypotheses Hₘ using K recognition parameters λₖ=(W_{L,k}, P_{I,k}), gives ranks rank_{m,k} to the M recognition hypotheses Hₘ with respect to each of the recognition parameters λₖ (S102-2), and outputs the given ranks. Note that K is an integer of 1 or more, and k=1, 2, . . . , K. Although, in the present embodiment, the recognition parameters λₖ are combinations of the language weight W_{L,k} and the insertion penalty P_{I,k}, the recognition parameters λₖ need only at least include the language weight W_{L,k} or the insertion penalty P_{I,k}.

The reranking portion 102-2 reranks the recognition hypotheses Hₘ obtained through recognition by the speech recognition portion 101, using the K recognition parameters λₖ. Here, the reranking portion 102-2 calculates an overall score x_{m,k} for each of the recognition hypotheses Hₘ when the parameters of the language weight and the insertion penalty are gradually changed, and the recognition hypotheses are ranked. The overall score x_{m,k} can be calculated using the following formula.

x_{m,k}=(1−W_{L,k})x_{A,m}+W_{L,k}x_{L,m}+P_{I,k}nₘ (3)

Here, x_{m,k} denotes the overall score, x_{A,m} denotes the acoustic score, x_{L,m} denotes the language score, nₘ denotes the number of words or the like, W_{L,k} denotes the language weight, and P_{I,k} denotes the insertion penalty. The formula (3) is obtained by scaling the formula (1) such that the language weight W_{L,k} is within a range from 0 to 1. The acoustic score x_{A,m} and the language score x_{L,m} are scores of each recognition hypothesis Hₘ that are calculated by an acoustic model and a language model, respectively, of the speech recognition portion, and the number of words or the like nₘ is obtained by counting the number of words or characters of each recognition hypothesis Hₘ. Since the acoustic score x_{A,m}, the language score x_{L,m}, and the number of words or the like nₘ are predetermined for each recognition hypothesis Hₘ, the ranking of the recognition hypotheses is changed by changing the values of the language weight W_{L,k} and the insertion penalty P_{I,k}. The reranking portion 102-2 changes the value of the language weight W_{L,k} by 0.01 at a time from 0 to 1, and changes the value of the insertion penalty P_{I,k} by 0.1 at a time from 0 to 10, for example. The reranking portion 102-2 calculates the overall score x_{m,k} for each recognition hypothesis Hₘ with respect to each combination of the parameters (in this example, there are 100×100=10000 combinations, and K=10000), and gives the rank rank_{m,k}. For example, the reranking portion 102-2 gives the rank rank_{m,k} to each recognition hypothesis Hₘ with respect to each of the recognition parameters λₖ=(W_{L,k}, P_{I,k}), based on the overall score x_{m,k}. In this case, a rank rank_{m′,k′} indicates the rank of a certain recognition hypothesis H_{m′} obtained with a certain recognition parameter λ_{k′}.

<Optimal Parameter Calculation Portion 102-3>

The optimal parameter calculation portion 102-3 accepts input of the evaluation value Eₘ and the rank rank_{m,k}, obtains, based on these values, an optimal value of the recognition parameter or a value that represents inappropriateness of each recognition parameter λₖ as a calculation result (S102-3), and outputs the obtained value.

For example, the optimal parameter calculation portion 102-3 calculates the goodness of each recognition parameter λₖ=(W_{L,k}, P_{I,k}) by calculating the evaluation values Eₘ of the top-ranked recognition hypotheses Hₘ with respect to each recognition parameter λₖ=(W_{L,k}, P_{I,k}).

For example, in the case of obtaining an optimal value of the recognition parameter, the optimal parameter calculation portion 102-3 focuses on a recognition hypothesis Hₘ that is reranked first with respect to the value of each recognition parameter λₖ=(W_{L,k}, P_{I,k}), calculates a centroid of the region of the recognition parameter λₖ=(W_{L,k}, P_{I,k}) with which the recognition hypothesis Hₘ whose evaluation value Eₘ, such as a sentence correct answer rate or a character correct answer accuracy, is 1 is ranked first, and sets the calculated centroid as the optimum value of the recognition parameter.

In the case of obtaining a value that represents the inappropriateness of each recognition parameter λₖ, for example, the optimal parameter calculation portion 102-3 outputs the following loss function L(λₖ) that represents the distance from a region S of the recognition parameter with which the recognition parameter whose evaluation value Eₘ, such as the sentence correct answer rate, is 1 is ranked first. The later-described model learning portion 103 can learn a model based on L(λₖ).

$$[ Math 1 ]$$

$$L ( {λ}_{k} ) = {min}_{λ ∈ {S}^{- ε}} \vert {λ}_{k} - λ \vert \qquad ( 4 )$$

Here, a region S^{-ε} indicates a region obtained by deleting an outer peripheral portion ε from the region S of the recognition parameter with which the evaluation value Eₘ, such as the sentence correct answer rate, is 1, and λ∈S^{-ε} denotes a recognition parameter that belongs to the region S^{-ε}. The formula (4) qualitatively represents the badness of each recognition parameter λₖ, i.e., is a value that represents inappropriateness.

It is also possible to employ a method of setting a loss function with which a recognition hypothesis that is discriminatively correct is more likely to come to the top, using up to the first to Nth-ranked recognition hypotheses. Reference Literature 2 is a known technique for the design of such a loss function.
(Reference Literature 2) Och, F. J., “Minimum error rate training in statistical machine translation”, Association for Computational Linguistics, In Proceedings of the 41st Annual Meeting on Association for Computation al Linguistics-Volume 1, pp. 160-167, 2003.
   In Reference Literature 2, the model learning portion 103 is trained to lower the scores of recognition hypotheses that include an error, of the first to Nth-ranked recognition hypotheses.

<Model Learning Portion 103>

The model learning portion 103 accepts input of the acoustic feature value sequence O and the result of calculation by the optimal parameter calculation portion 102-3, learns, using these values, a regression model for estimating an optimal recognition parameter from an acoustic feature value sequence (S103), performs the same processing on P acoustic feature value sequences O for learning and the transcription data thereof, and outputs the learned regression model.

For example, the model learning portion 103 learns the regression model for estimating an optimal recognition parameter obtained by the optimal parameter estimation portion 102 from an acoustic feature value sequence, using a known deep learning technique. The aforementioned learning technique is a framework for supervised training, and the model learning portion 103 uses, in the learning, an acoustic feature value sequence of a speech file as an input feature value, and uses the result of calculation by the optimal parameter calculation portion 102-3 as a correct-answer label. The model learning portion 103 uses, for example, the mean square error as the loss function. It may be modeled by an RNN, an LSTM, an attentive LSTM model, or the like that can also consider long-term time-series information.

If the result of calculation by the optimal parameter calculation portion 102-3 is a unique optimal recognition parameter, the model learning portion 103 obtains, as the loss function, the mean square error of a parameter obtained when the acoustic feature value sequence is given to the model that is being learned and the optimal recognition parameter, and learns the model such that the loss function is small.

If the result of calculation by the optimal parameter calculation portion 102-3 is a loss function, the model learning portion 103 learns the model such that the loss function is small.

Note that the data for learning is divided into training data and validation data, and hyperparameters such as the number of epochs for finishing learning are determined through evaluation on the validation data.

### Second Embodiment

A description will be given mainly of differences from the first embodiment.

The present embodiment will describe a speech recognition method that uses the learned regression model described in the first embodiment.

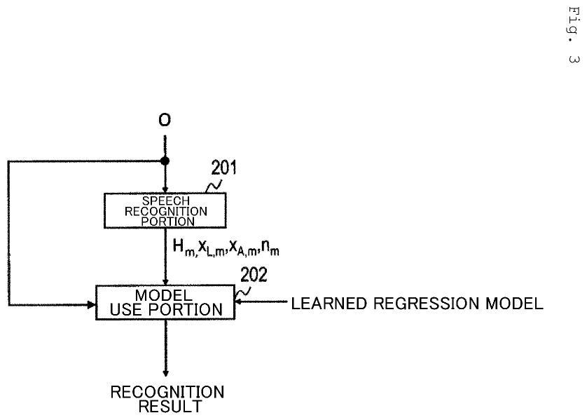

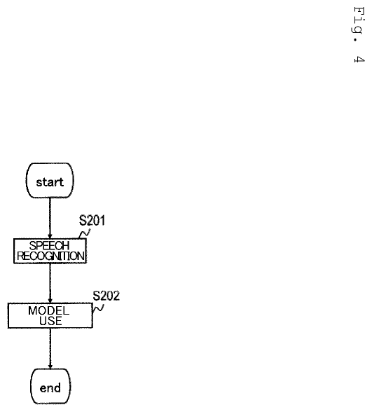

FIG. 3 is a functional block diagram of a speech recognition device according to the second embodiment, and FIG. 4 shows a processing flow thereof.

The speech recognition device includes a speech recognition portion 201 and a model use portion 202.

The speech recognition device accepts input of an acoustic feature value sequence Oₜ of speech data subjected to speech recognition, reranks the recognition results of speech recognition performed using a recognition parameter λᵢₙᵢ, with a recognition parameter estimated using the learned regression model, and outputs the highest rank recognition result as the recognition result. The subscript t denotes an index indicating data that is subjected to speech recognition. Since the present embodiment only describes processing for the acoustic feature value sequence Oₜ of speech data subjected to speech recognition, the index t is omitted.

Each portion will be described below.

<Speech Recognition Portion 201>

The speech recognition portion 201 is the same as the speech recognition portion 101. That is to say, the speech recognition portion 201 accepts input of an acoustic feature value sequence O of an utterance unit, performs speech recognition processing on the acoustic feature value sequence O of the utterance unit using the recognition parameter λᵢₙᵢ (S201), and obtains M recognition hypotheses Hₘ and M overall scores xₘ. However, the input acoustic feature value sequence O of the utterance unit is an acoustic feature value sequence of speech data subjected to speech recognition.

The speech recognition portion 201 outputs, to the model use portion 202, the M recognition hypotheses Hₘ, and M combinations of the language score x_{L,m}, the acoustic score x_{A,m}, and the number of words or the like nₘ that are obtained in the process of obtaining the M overall scores xₘ.

<Model Use Portion 202>

The model use portion 202 accepts input of the acoustic feature value sequence O of the utterance unit, the M recognition hypotheses Hₘ, and the M combinations of the language score x_{L,m}, the acoustic score x_{A,m}, and the number of words or the like nₘ, and obtains a recognition parameter λ_{E}+(W_{L,E}, P_{I,E}) for the acoustic feature value sequence O, using the regression model for estimating an optimal recognition parameter from an acoustic feature value sequence. The model use portion 202 obtains M overall scores x_{E,m} for the M recognition hypotheses Hₘ using the obtained recognition parameter λ_{E}.

x_{E,m}=(1−W_{L,E})x_{A,m}+W_{L,E}x_{L,m}+P_{I,E}nₘ

The model use portion 202 ranks (reranks) the M recognition hypotheses Hₘ based on the obtained M overall scores x_{E,m} (S202), and outputs the top-ranked recognition hypothesis as the recognition result. That is to say, in the present embodiment, the model use portion 202 estimates the recognition parameter λ_{E} at the same time as when the speech recognition portion 201 performs speech recognition, and reranks the recognition hypotheses output from the speech recognition portion 201.

The recognition parameter λ_{E} is estimated for each one utterance unit, and speech recognition is performed with a recognition parameter appropriate for each one utterance unit.

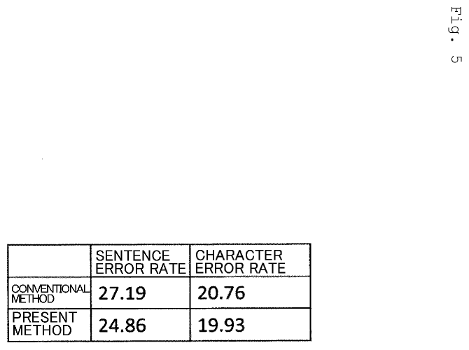

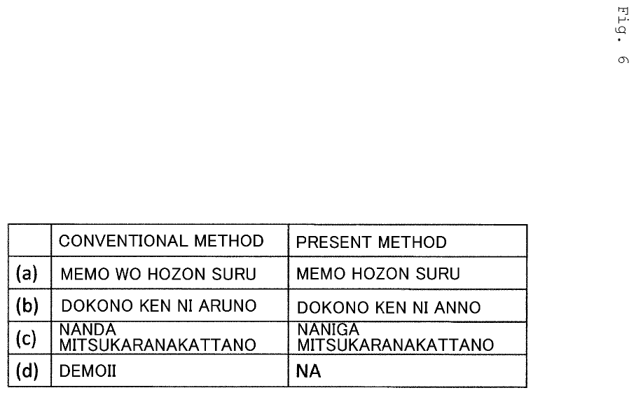

FIG. 5 is a diagram showing a sentence error rate and a character error rate in a conventional method and the present method. As shown in FIG. 5, application of the present method realized an about 9% reduction in the sentence error rate and an about 4% reduction in the character error rate for actual service log speech. FIG. 6 is a diagram showing cases of improvement as a result of applying the present method. An example (a) in which a postpositional particle omitted in a colloquial expression was correctly recognized, an example (b) in which an expression spoken with a provincial accent was correctly recognized, an example (c) in which speech was grammatically correctly recognized, and an example (d) a void recognition result was correctly returned to a background utterance to which a recognized result is originally not to be returned, were observed.

<Effects>

The above configuration achieves an effect that an appropriate recognition parameter can be estimated for each utterance without relying on the results of noise estimation. In addition, recognition accuracy improves compared with the case where a fixed recognition parameter is set for the entire dataset. By applying an appropriate recognition parameter for each utterance as reranking, the recognition parameter can be estimated in parallel with speech recognition and can be applied without delay.

### Third Embodiment

A description will be given mainly of differences from the first embodiment.

In the case of applying the present method as reranking as in the first embodiment, the applicable parameters are limited to the language model weight and the insertion error. However, in the case of applying the present method as preprocessing of speech recognition, the present method can also be applied to recognition parameters such as a beam width and a bias value in addition to the language weight and the insertion error, and optimization on a sentence-by-sentence basis is enabled. In the present embodiment, a model for estimating an optimal parameter on a sentence-by-sentence basis is learned by performing recognition more than once while changing each parameter.

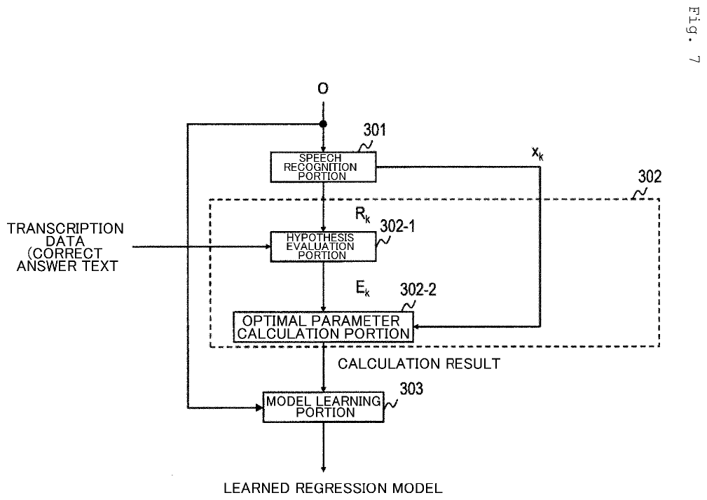

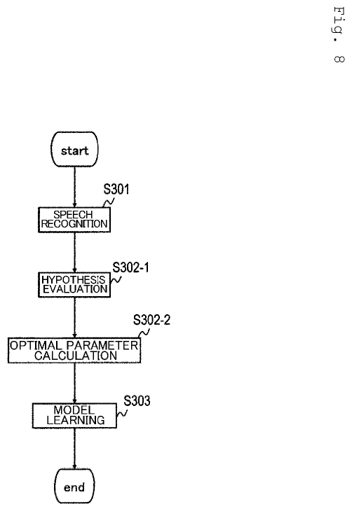

FIG. 7 is a functional block diagram of a learning device according to the third embodiment, and FIG. 8 shows a processing flow thereof.

The learning device includes a speech recognition portion 301, a hypothesis evaluation portion 302-1, an optimal parameter calculation portion 302-2, and a model learning portion 303.

The learning device accepts input of an acoustic feature value sequence O for learning and transcription data obtained by a person transcribing corresponding speech data, learns a regression model for estimating an optimal recognition parameter from an acoustic feature value sequence, and outputs the learned regression model.

Each portion will be described below.

<Speech Recognition Portion 301>

The speech recognition portion 301 accepts input of an acoustic feature value sequence O of an utterance unit, performs speech recognition processing on the acoustic feature value sequence O of the utterance unit using K recognition parameters λₖ (S301), and obtains K recognition results Rₖ and K overall scores xₖ.

The speech recognition portion 301 outputs the K recognition results Rₖ to the hypothesis evaluation portion 302-1, and outputs K overall scores xₖ to the optimal parameter calculation portion 302-2.

The speech recognition portion 301 performs recognition using a known speech recognition technique while gradually changing a set value of a recognition parameter to be optimized, and acquires a recognition result for each recognition parameter.

A later-described optimal parameter estimation portion 302, which is constituted by the hypothesis evaluation portion 302-1 and the optimal parameter calculation portion 302-2, evaluates the recognition result with respect to each recognition parameter output from the speech recognition portion 301, and outputs an optimal recognition parameter. The optimal parameter estimation portion 102 of the first embodiment simulates the recognition result with respect to each recognition parameter by reranking the recognition hypotheses with each recognition parameter at the reranking portion 102-2. In contrast, in the present embodiment, the reranking process is not necessary because recognition has already been performed while changing the recognition parameter at the speech recognition portion 301.

Note that the recognition parameters λₖ of the present embodiment include at least one of the speech recognition parameters such as the language weight, the insertion penalty, the beam width, and the bias value.

<Hypothesis Evaluation Portion 302-1>

The hypothesis evaluation portion 302-1 performs the same process as the hypothesis evaluation portion 102-1 of the first embodiment. That is to say, the hypothesis evaluation portion 302-1 accepts input of the recognition results Rₖ and correct answer texts, evaluates the recognition results Rₖ based on the correct answer texts, obtains evaluation values Eₖ(S302-1), and outputs the obtained evaluation values Eₖ.

<Optimal Parameter Calculation Portion 302-2>

The optimal parameter calculation portion 302-2 accepts input of the overall scores xₖ and the evaluation value Eₖ for the recognition results Rₖ, obtains, based on these values, an optimal value of the recognition parameter or a value that represents inappropriateness of the recognition parameters λₖ as a calculation result (S302-2), and outputs the obtained value.

The optimal parameter calculation portion 302-2 quantifies the goodness of each recognition parameter by considering the evaluation value of the recognition result obtained with respect to each recognition parameter, using the recognition result obtained with each recognition parameter and the evaluation value for these recognition results that are obtained at the hypothesis evaluation portion 302-1. The details are the same as those of the optimal parameter calculation portion 102-3.

For example, in the case of obtaining an optimum value of a recognition parameter, a recognition parameter λₖ corresponding to the recognition result Rₖ whose an evaluation value Eₖ is 1 is extracted, a centroid of the extracted recognition parameter λₖ is calculated, and the calculated centroid is used as an optimum value of the recognition parameter.

In the case of obtaining a value that represents inappropriateness of the recognition parameter λₖ, for example, the optimal parameter calculation portion 102-3 outputs a loss function L(λₖ) of a formula (4) that represents the distance from a region S of the recognition parameter with which the recognition result Rₖ whose evaluation value Eₘ, such as the sentence correct answer rate, is 1 is ranked first. By using a loss function that enables calculation based only on the recognition result with a certain parameter (and its periphery), as with the loss function L(λₖ) of the formula (4), it is possible to numerically differentiate the value of loss with the recognition parameter and sequentially update the recognition parameter in the manner of gradient descent.

<Model Learning Portion 303>

The model learning portion 303 performs the same processing as the model learning portion 103 of the first embodiment. That is to say, the model learning portion 303 accepts input of the acoustic feature value sequence O and the result of calculation by the optimal parameter calculation portion 302-2, learns, using these values, a regression model for estimating an optimal recognition parameter from an acoustic feature value sequence (S303), performs the same processing on P acoustic feature value sequences O for learning and transcription data thereof, and outputs the learned regression model.

<Effects>

With this configuration, the same effects as the first embodiment can be obtained. Furthermore, in the present embodiment, the beam width and the bias value can be used as the recognition parameters λ_{E} to be estimated by the regression model. However, since speech recognition processing is performed using K recognition parameters λₖ in the present embodiment, the amount of calculation is larger than that of the first embodiment.

### Fourth Embodiment

A description will be given mainly of differences from the second embodiment.

In the present embodiment, an optimal parameter is estimated using the model learned in the third embodiment, and this optimal parameter is used as a set value of a parameter of the speech recognition portion to perform speech recognition.

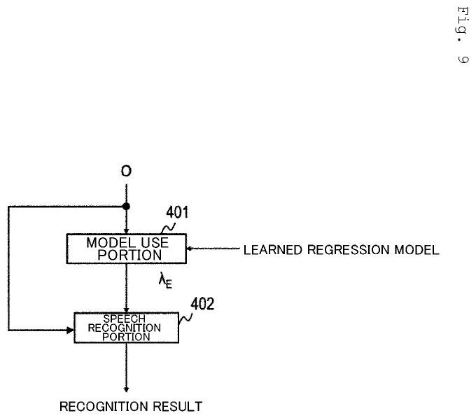

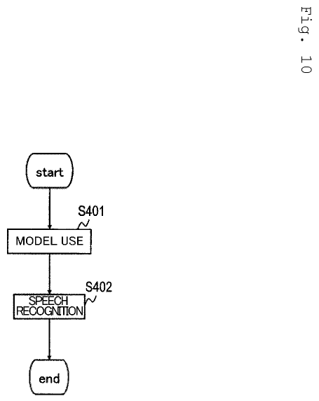

FIG. 9 is a functional block diagram of a speech recognition device according to the fourth embodiment, and FIG. 10 shows a processing flow thereof.

The speech recognition device includes a speech recognition portion 402 and a model use portion 401.

The speech recognition device accepts input of an acoustic feature value sequence O of speech data subjected to speech recognition, estimates an optimal recognition parameter using a learned regression model, performs speech recognition using the estimated recognition parameter, and outputs a recognition result.

Each portion will be described below.

<Model Use Portion 401>

The model use portion 401 accepts input of the acoustic feature value sequence O, obtains a recognition parameter λ_{E} for the acoustic feature value sequence O of an utterance unit using a regression model for estimating an optimal recognition parameter from the acoustic feature value sequence (S401), and outputs the obtained recognition parameter. Note that the regression model is the model learned in the third embodiment.

Before speech recognition processing is performed by the speech recognition portion 402, the model use portion 401 estimates an optimal recognition parameter, and the speech recognition portion 402 performs speech recognition using the estimated optimal recognition parameter. When recognition results are searched in the speech recognition portion 402, an appropriate hypothesis search can be performed by giving the estimated recognition parameter as a set value.

<Speech Recognition Portion 402>

The speech recognition portion 402 accepts input of the acoustic feature value sequence O and the recognition parameter λ_{E}, performs speech recognition processing on the acoustic feature value sequence O of the utterance unit using the recognition parameter λ_{E} (S402), and outputs the recognition result.

<Effects>

With this configuration, the same effects as the second embodiment can be obtained. Furthermore, in the present embodiment, the beam width and the bias value can be used as the recognition parameters λ_{E} to be estimated.

<Other Modifications>

The present invention is not limited to the above embodiments and modifications. For example, various types of processing described above may be not only performed in time-series in accordance the description, but also performed in parallel or separately in accordance with the performance of the device that performs processing, or as necessary. In addition, the present invention may be modified as appropriate within the scope of the gist thereof.

<Program and Recording Medium>

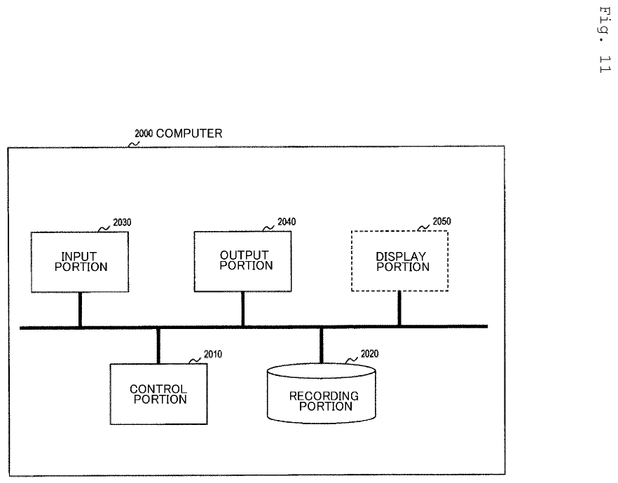

Various kinds of processing described above can be carried out by causing a recording portion 2020 of a computer shown in FIG. 11 to load a program for executing the steps in the above-described method, and causing a control portion 2010, an input portion 2030, an output portion 2040, and so on, to operate.

The program in which this processing content is written can be recorded in a computer-readable recording medium. The computer-readable recording medium may be of any kind; e.g., a magnetic recording device, an optical disk, a magneto-optical recording medium, a semiconductor memory, or the like.

This program is distributed by, for example, selling, transferring, or lending a portable recording medium, such as a DVD or a CD-ROM, in which the program is recorded. Furthermore, a configuration is also possible in which this program is stored in a storage device in a server computer, and is distributed by transferring the program from the server computer to other computers via a network.

For example, first, a computer that executes this program stores the program recorded in the portable recording medium or the program transferred from the server computer, in a storage device of this computer. When performing processing, the computer reads the program stored in its own storage medium, and performs processing in accordance with the loaded program. As another mode of executing this program, the computer may directly read the program from the portable recording medium and perform processing in accordance with the program, or may sequentially perform processing in accordance with a received program every time the program is transferred to this computer from the server computer. A configuration is also possible in which the above-described processing is performed through a so-called ASP (Application Service Provider)-type service that realizes processing functions only by giving instructions to execute the program and acquiring the results, without transferring the program to this computer from the server computer. Note that the program in this mode may include information for use in processing performed by an electronic computer that is equivalent to a program (data or the like that is not a direct command to the computer but has properties that define computer processing).

In this mode, the present devices are configured by executing a predetermined program on a computer, but the content of this processing may be at least partially realized in a hardware manner.

1. A learning device comprising:
a memory; and
a processor coupled to the memory and configured to perform a method, comprising:
performing speech recognition processing on an acoustic feature value sequence O of an utterance unit using a recognition parameter λᵢₙᵢ;
obtaining a recognition hypothesis Hₘ and an overall score xₘ, where M is an integer of 1 or more and m=1, 2, . . . , M; and
evaluating the recognition hypothesis Hₘ and obtain an evaluation value Eₘ using a correct answer text that is a correct speech recognition result for the acoustic feature value sequence O:
obtaining an overall score x_{m,k} for the recognition hypothesis Hₘ and give a rank rank_{m,k} thereto using a recognition parameter λₖ, where K is an integer of 1 or more and k=1, 2, . . . , K;
obtaining, as a calculation result, an optimal value of a recognition parameter or a value expressing inappropriateness of the recognition parameter λₖ based on the evaluation value Eₘ and the rank rank_{m,k}; and
learning a regression model for estimating an optimal recognition parameter from an acoustic feature value sequence, using the acoustic feature value sequence O and the calculation result.

2. A speech recognition device comprising:
a memory; and
a processor coupled to the memory and configured to perform a method, comprising:
performing speech recognition processing on an acoustic feature value sequence O of an utterance unit using a recognition parameter λᵢₙᵢ;
obtaining a recognition hypothesis Hₘ and an overall score xₘ, where M is an integer of 1 or more and m=1, 2, . . . , M;
obtaining a recognition parameter λ_{E} for the acoustic feature value sequence O using a regression model for estimating an optimal recognition parameter from an acoustic feature value sequence;
obtaining an overall score x_{E,m} for the recognition hypothesis Hₘ using the obtained recognition parameter λ_{E}; and
ranking the recognition hypothesis Hₘ based on the obtained overall score x_{E,m}.

3. A learning device comprising:
a memory; and
a processor coupled to the memory and configured to perform a method, comprising:
performing speech recognition processing on an acoustic feature value sequence O of an utterance unit using a recognition parameter λₖ;
obtaining a recognition result Rₖ and an overall score xₖ, where K is an integer of 1 or more and k=1, 2, . . . , K;
evaluating the recognition result Rₖ;
obtaining an evaluation value Eₖ using a correct answer text that is a correct speech recognition result for the acoustic feature value sequence O;
obtaining, as a calculation result, an optimal value of a recognition parameter or a value expressing inappropriateness of the recognition parameter λₖ based on the overall score xₖ and the evaluation value Eₖ for the recognition result Rₖ; and
learning a regression model for estimating an optimal recognition parameter from an acoustic feature value sequence, using the acoustic feature value sequence O and the calculation result.

4-9. (canceled)

10. The learning device according to claim 1, wherein the optimal recognition parameter has no dependency on noise recognition.

11. The learning device according to claim 1, wherein the performing speech recognition processing includes estimating speech recognition processing parameters using a neural network.

12. The learning device according to claim 1, wherein each acoustic feature of the acoustic feature value sequence O corresponds to an utterance.

13. The speech recognition device according to claim 2, wherein the optimal recognition parameter has no dependency on noise recognition.

14. The speech recognition device according to claim 2, wherein the performing speech recognition processing includes estimating speech recognition processing parameters using a neural network.

15. The speech recognition device according to claim 2, wherein each acoustic feature of the acoustic feature value sequence O corresponds to an utterance.

16. The learning device according to claim 3, wherein the optimal recognition parameter has no dependency on noise recognition.

17. The learning device according to claim 3, wherein the performing speech recognition processing includes estimating speech recognition processing parameters using a neural network.

18. The learning device according to claim 3, wherein each acoustic feature of the acoustic feature value sequence O corresponds to an utterance.
